(19) United States
(12) Patent Application Publication
(10) Pub. No.: US 2008/0018928 A1
(43) Pub. Date: Jan. 24, 2008

(54) Apparatus and method for report invocation and manipulation on a mobile communication device

(75) Inventors: Ali Meziani, Paris (FR); Charles Arthur Piercey, Paris (FR); Jean-Claude Grosselin, Viroflay (FR); Fabrice Delaporte, Courbevoie (FR)

Correspondence Address: COOLEY GODWARD KRONISH LLP;ATTN: Patent Group, Suite 1100, 777 - 6th Street, NW, Washington, DC, 20001, US

(73) Assignee: Business Objects, S.A., Levallois-Perret (FR)

(21) Appl. No.: 11/488,460

(22) Filed: Jul. 17, 2006

(51) Int. Cl. G06F 3/12

(52) U.S. Cl. 358/1.15

(57) ABSTRACT

A computer implemented method includes receiving a request to view a report document on a mobile communication device. The request is passed over a wireless channel to a server. A report document is received from the server over a wireless channel. The report document is displayed on the mobile communication device.

### BRIEF DESCRIPTION OF THE INVENTION

This invention relates generally to reporting and mobile communication devices. More particularly, this invention relates to accessing and manipulating reports on a mobile communication device in an interactive manner.

### BACKGROUND OF THE INVENTION

A mobile communication device refers to a hand-sized data processor that communicates through a wireless network. Cell phones and Blackberries™ are examples of mobile communication devices. Mobile communication devices are designed to be small and portable, which generally limits the screen real estate that is available to display data.

Although the prior art includes distribution of reports to a range of devices, it has not addressed the challenges of presenting reports on the small screens associated with mobile communication devices or providing interactivity options that are optimized for these devices.

Business Intelligence (BI) generally refers to software tools used to improve business enterprise decision-making. These tools are commonly applied to financial, human resource, marketing, sales, customer and supplier analyses. More specifically, these tools can include: reporting and analysis tools to present information; content delivery infrastructure systems for delivery and management of reports and analytics; data warehousing systems for cleansing and consolidating information from disparate sources; and data management systems, such as relational databases or On Line Analytic Processing (OLAP) systems used to collect, store, and manage raw data.

A subset of business intelligence tools are report generation tools. There are a number of commercially available products to produce reports from stored data. For instance, Business Objects Americas of San Jose, Calif., sells a number of widely used report generation products, including Crystal Reports™, Business Objects OLAP Intelligence™, Business Objects Web Intelligence™, and Business Objects Enterprise™. As used herein, the term report refers to information automatically retrieved (i.e., in response to computer executable instructions) from a data source (e.g., a database, a data warehouse, a plurality of reports, and the like), where the information is structured in accordance with a report schema that specifies the form in which the information should be presented. A non-report is an electronic document that is constructed without the automatic retrieval of information from a data source. Examples of non-report electronic documents include typical business application documents, such as a word processor document, a presentation document, and the like.

A report document specifies how to access data and format it. A report document where the content does not include external data, either saved within the report or accessed live, is a template document for a report rather than a report document. Unlike other non-report documents that may optionally import external data within a document, a report document by design is primarily a medium for accessing and formatting, transforming or presenting external data.

A report is specifically designed to facilitate working with external data sources. In addition to information regarding external data source connection drivers, the report may specify advanced filtering of data, information for combining data from different external data sources, information for updating join structures and relationships in report data, and logic to support a more complex internal data model (that may include additional constraints, relationships, and metadata).

In contrast to a spreadsheet, a report is generally not limited to a table structure but can support a range of structures, such as sections, cross-tables, synchronized tables, sub-reports, hybrid charts, and the like. A report is designed primarily to support imported external data, whereas a spreadsheet equally facilitates manually entered data and imported data. In both cases, a spreadsheet applies a spatial logic that is based on the table cell layout within the spreadsheet in order to interpret data and perform calculations on the data. In contrast, a report is not limited to logic that is based on the display of the data, but rather can interpret the data and perform calculations based on the original (or a redefined) data structure and meaning of the imported data. The report may also interpret the data and perform calculations based on pre-existing relationships between elements of imported data. Spreadsheets generally work within a looping calculation model, whereas a report may support a range of calculation models. Although there may be an overlap in the function of a spreadsheet document and a report document, these documents express different assumptions concerning the existence of an external data source and different logical approaches to interpreting and manipulating imported data.

To date, mobile communication devices, business intelligence, and particularly interactive report display and mobile communication device display techniques, have operated in different domains. It would be desirable to provide techniques to integrate these separate domains.

### SUMMARY OF INVENTION

The invention includes a computer implemented method of authenticating a user of a mobile communication device. A request from the mobile communication device for report content is processed. The report content is transmitted to the mobile communication device.

The invention also includes a computer implemented method of receiving a request to view a report document on a mobile communication device. The request is passed over a wireless channel to a server. A report document is received from the server over a wireless channel. The report document is displayed on the mobile communication device.

The invention also includes a computer readable medium with executable instructions to facilitate the design of a report for use and display on a mobile communication device. Information identifying a data source is received. Information specifying a mobile communication device is accepted. The mobile communication device is displayed. A report is saved to a location accessible to the mobile communication device.

The invention also includes a computer readable medium with executable instructions for viewing reports on a mobile communication device. A report document is received. The report document is interpreted. The report document is then rendered on the mobile communication device.

### BRIEF DESCRIPTION OF THE FIGURES

The invention is more fully appreciated in connection with the following detailed description taken in conjunction with the accompanying drawings, in which:

FIG. 1 illustrates a network architecture configured in accordance with an embodiment of the invention.

FIG. 2 illustrates a workflow associated with an embodiment of the invention.

FIG. 3 illustrates a workflow associated with an embodiment of the invention.

FIG. 4 illustrates a workflow associated with an embodiment of the invention.

FIG. 5 illustrates a workflow associated with an embodiment of the invention.

FIGS. 6-9 illustrate a graphical user interface (GUI) that may be utilized on a mobile communication device in accordance with an embodiment of the invention.

FIGS. 10-11 illustrate a report design tool that may be used in accordance with embodiments of the invention.

Like reference numerals refer to corresponding parts throughout the several views of the drawings.

### DETAILED DESCRIPTION OF THE INVENTION

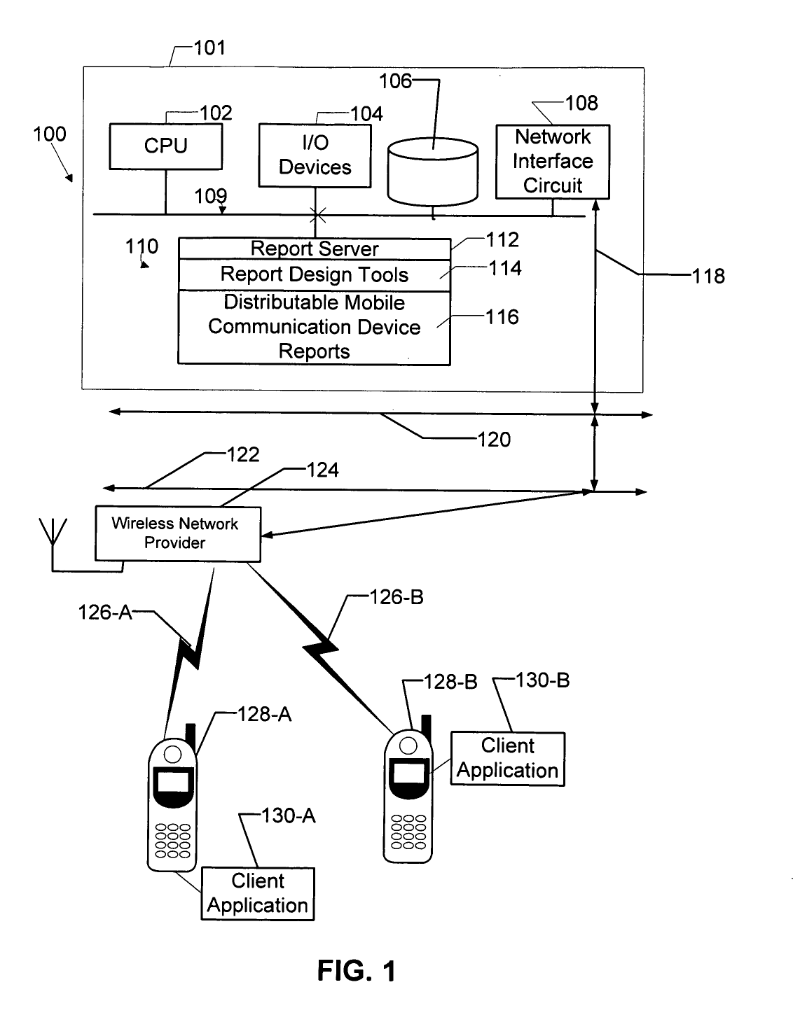

FIG. 1 illustrates a system 100 configured in accordance with an embodiment of the invention. The system 100 includes a server 101 with a central processing unit 102, a set of input/output devices 104, a storage device 106, and a network interface circuit 108 linked by a bus 109. The input/output devices 104 may include standard components, such as a keyboard, mouse, monitor, printer, and the like. Using the Network Interface Circuit 108, report documents and optionally other files such as client applications or patches for the client devices are passed through an option internal firewall 120 and an optional external firewall 122 where they are passed to a wireless network provider 124.

A memory 110 (e.g., a volatile memory loading data from the storage device 106) stores a report server 112, report design tools 114, and distributable mobile communication device reports 116. The report server 112 supplies standard report serving functionality. In one embodiment, report design tools 114 facilitate the creation of distributable mobile communication device reports 116 in accordance with the invention.

Mobile communication devices 128-A and 128-B independently access one or more distributable mobile communication device reports 116. Each mobile device has a client application 130 to facilitate requesting, viewing and manipulating report documents. In one embodiment, the client application is downloaded from the server 101 using the same type of network architecture used to deliver the distributable mobile communication device reports 116.

Link 118 supports the flow of data packets that describe reports provided by the report server 112 and requests from the client application 130A, 130B for specific reports. Reports are passed through the wireless network provider 124 to the mobile communication device 128-A, 128-B where the client application 130-A, 130-B facilitates viewing the report and requesting refreshed or different report content. When a request is made from the mobile communication device, it is passed back through the network to the system 100 containing the report server 112.

The network configuration and executable modules stored in memory 110 are exemplary. It should be appreciated that the functions of the modules may be combined. In addition, the functions of the modules need not be performed on a single machine. Instead, the functions may be distributed across a network, if desired. It is the functions of the invention that are significant, not where they are performed or the specific manner in which they are performed.

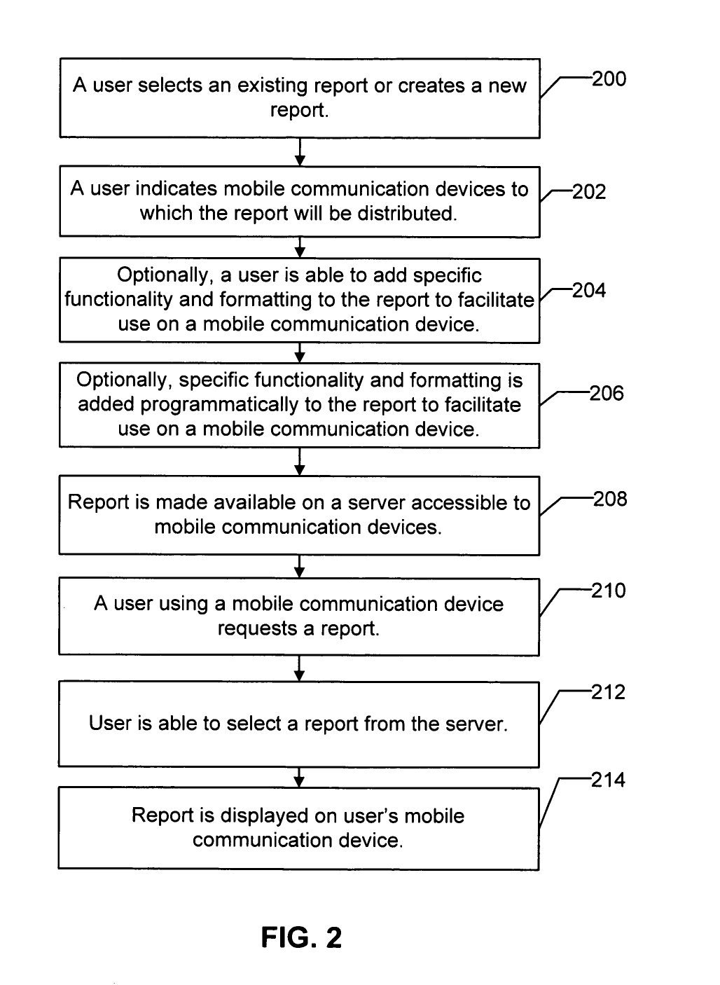

FIG. 2 illustrates a workflow for viewing a distributable mobile communication device report on a mobile communication device in accordance with an embodiment of the invention. A user selects an existing report or creates a new report 200. The user indicates mobile communication devices to which the report will be distributed 202. Optionally, the user is able to add specific functionality or formatting to the report to facilitate use on a mobile communication device 204. This optional functionality includes shortened drill labels, icon based trend indicators, optimized chart formats, drill and parameter options, navigational shortcuts and the like. Optionally, specific functionality or formatting is added programmatically to the report to facilitate report use on a mobile device 206. In one embodiment, adding functionality and formatting to the report is done in the context of a validation wizard that corrects layout and adds additional navigational functionality. Typically, a user creates reports that are accessed by a larger group of mobile communication device users.

The report is available on a server accessible to mobile communication devices 208. Depending on the network configuration, this server may be accessed indirectly through additional servers, transmission protocols, networks, and the like. A user using a mobile communication device requests a report 210. This request may be either explicit, a request for all available reports, or based on a preference configuration. The user is able to select a report from the server 212. The report is displayed on the user's mobile communication device 214.

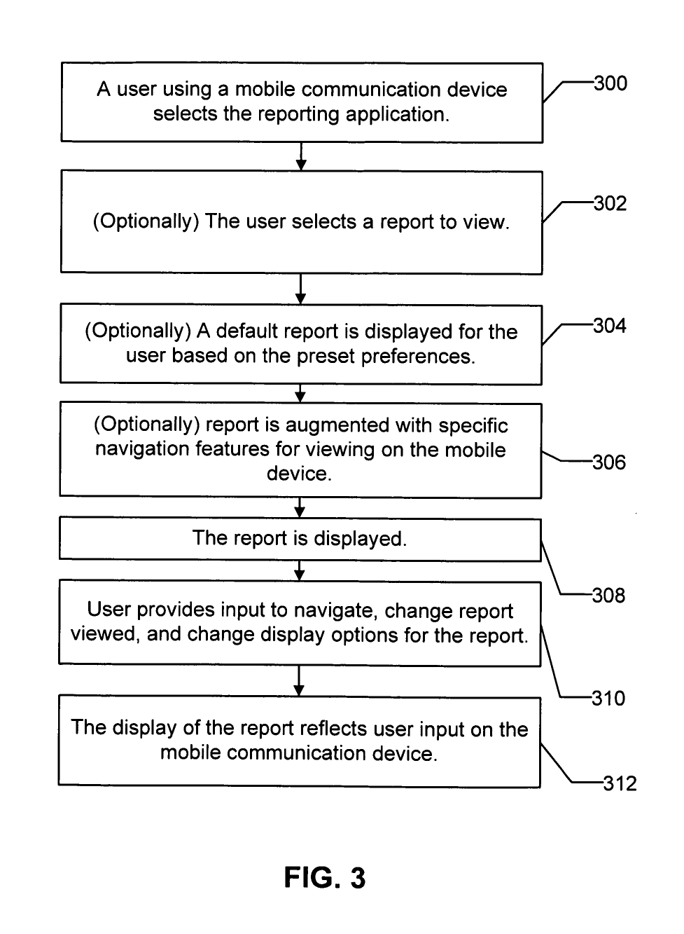

FIG. 3 illustrates a workflow associated with one embodiment of the invention. A user using a mobile communication device selects a reporting application 300. Optionally, the user selects a report to view 302 or a report is selected based on preset preferences 304. Selecting a report to view includes specifying a view of the report and parameters to use when generating the report.

Optionally, the report is augmented with specific navigation features to produce an augmented report document 306. In an embodiment, this occurs within the client reporting application. The report is displayed 308. The user provides input to navigate, change the report being viewed, change the view on the report, change parameters for the report, or change display options and the like 310. The display of the report reflects user input 312. In the case of changes that require a data refresh, a new request is sent to the server to request the document. In other cases, processing occurs on the mobile communication device.

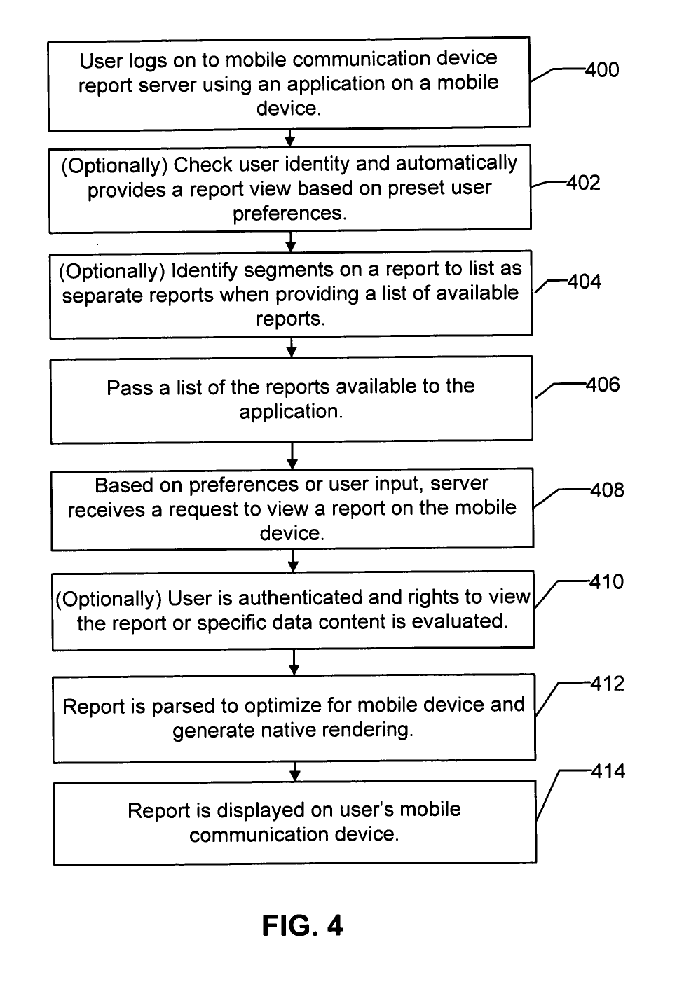

FIG. 4 illustrates a workflow associated with a user accessing a report document associated with an embodiment of the invention. A user logs on to a mobile communication device report server using an application on a mobile device 400. Optionally, the server checks user identity (i.e., authenticates the user). Part of the authentication operation may include confirming that the user has rights to access the requested report content. The server then provides a report based on preset user specified preferences or parameters 402. In one embodiment, the processing of user preferences occurs within the application on the mobile device. Optionally, the server identifies segments (such as tabs) within reports used to identify and separate report sections when providing a list of available reports 404. In one embodiment, the identification of report sections occurs on the client application. The server passes a list of available reports to the application 406. Based on either an explicit user selection or a previously set user preference, a request for a report, optionally including filters, parameters, and the like is sent to the server 408. Optionally, the user is authenticated and rights to view the report or specific report data content are evaluated 410. The report is parsed for optimized viewing on the mobile device and is generated with a native rendering 412. The report is displayed on the user's mobile communication device 414.

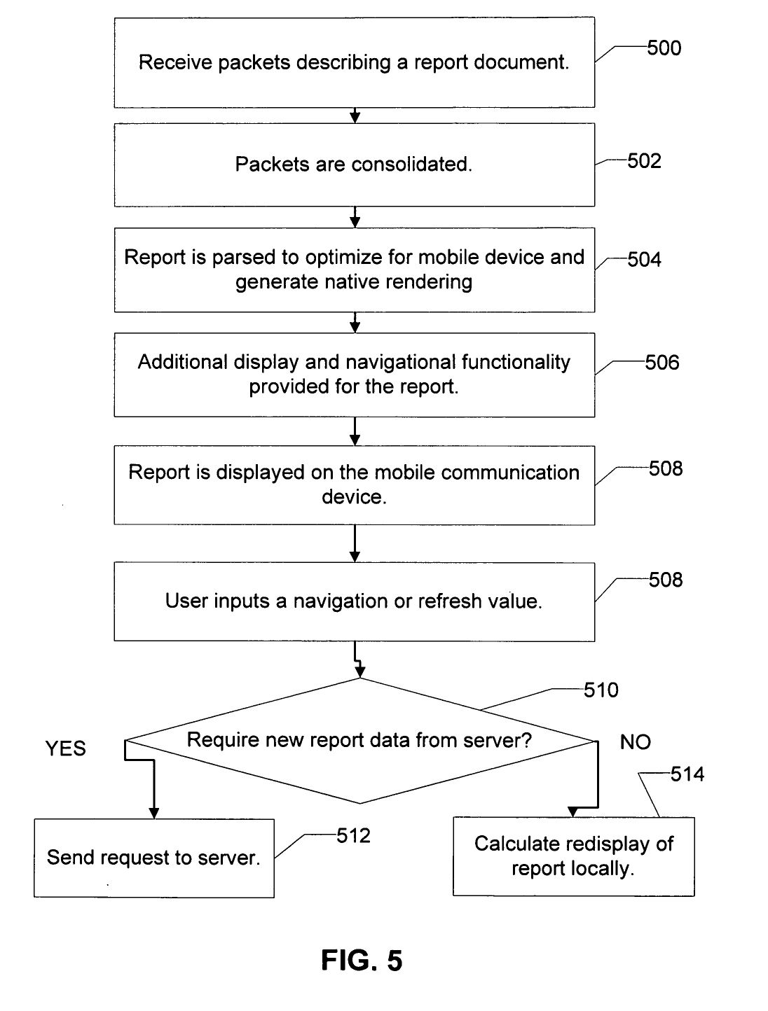

FIG. 5 illustrates a process for rendering a report on a mobile device associated with an embodiment of the invention. The report application on the mobile communication device receives one or more packets describing a report document 500. The packets are consolidated 502. The report is parsed and optimized for viewing on the mobile device and native rendering is generated 504. Additional display and navigational functionality is provided for the report 506. The report is displayed on the mobile communication device 508. The user inputs a refresh or navigation value 508. This input can be based on a hotkey, a menu selection, scrolling, selecting and drilling and the like. The input is evaluated to determine whether it requires new report data from the server 510. If YES, a request is sent to the server 512, if NO, the redisplay of the report is calculated locally 514.

In one embodiment of the invention, when the client application detects data packet loss it will try a series of parameter changes to fix the problem. In normal operation, the call will return the entire document. If normal document access does not work because of degraded network conditions, then the client application switches to packet mode and tries a decreasing series of packet sizes on its server requests until access succeeds or fails. The server varies the delivered packet sizes in response to the input from the client. When it switches to packet mode, the client application starts with a default size modifiable by the user in a “Server Settings” window. Upon switching to packet mode, the client application starts with the default packet size and then, if this first packet-based call fails, the client application decrements the packet size requested by one kilobyte and tries again, repeating the procedure until a call succeeds or the packet size reaches one kilobyte in length. If the network call fails at a one kilobyte data packet size, the client application presents an error message.

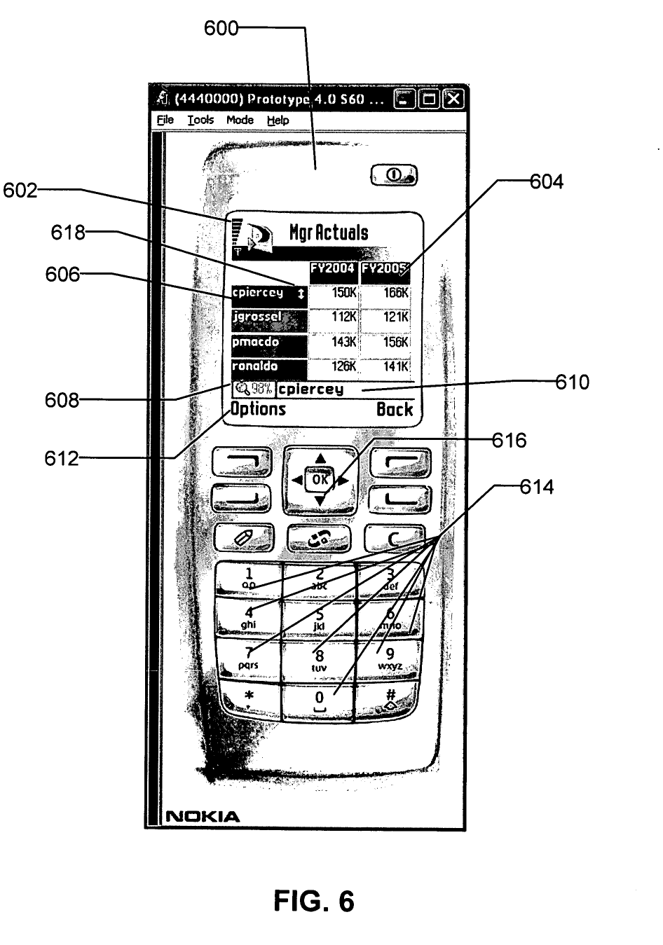

FIG. 6 illustrates a mobile communication device 600 in which the display 602 contains a report with a table chart 604. Specific navigation features include a cell view toolbar 610 that displays the selected cell so that the user can zoom in on values of particular interest. In this example, the toolbar 610 shows the content where the selected cell is indicated by 606. The cell zoom control 608 enables the user to control the zoom value when viewing a cell in the toolbar. Using hotkeys 614, the user can enable or disable the cell zoom toolbar. A second toolbar 612 provides “options” and “back” controls. As shown, a double headed icon 618 in the selected cell 606 indicates that both drill down and drill up functionality is available for the cell. Simply by clicking the OK button 616 with the cell selected 606, the user is able to drill down on the cell.

Keys on the mobile control device are enabled as hotkeys when viewing a report document. In one embodiment, the hotkey shortcuts have values as follows: Key 1=Show/Hide cell data and zoom status—pressing key #1 toggles on or off the Show Current Cell Value display line at the bottom of the screen in the status bar. Key 2=Fit Report to Full screen—pressing key #2 removes all titles and menus from the display and makes the entire device screen available for report viewing and navigation. Key 3: Lock Row & Column Headers—pressing key #3 locks the table headers to make them always visible as a user scrolls within the table. Key 4: Previous Page—pressing key #4 opens the previous report page. This menu item appears only in multi page reports. Key 5: 100% Rendering—pressing key # 5 sets the zoom to be 100% which means that 1 pixel on the original report will be represented by one pixel rendered on the mobile device. Key 6: Next Page—pressing key #6 opens the next report page. This menu item appears only in multi page reports. Key 7: Zoom-out—pressing key #7 will incrementally zoom OUT from the current view. Key 8: Fit to screen—pressing key #8 will set the zoom view so that the viewed report fits entirely within the mobile device screen.

Reports that are not designed for mobile devices may become quite small in which case their cells are replaced by “###”. In this case, users can still navigate a report and see cell values by pressing key #1 above. Key 9: Zoom-in—pressing key #9 will incrementally zoom in from the current view.

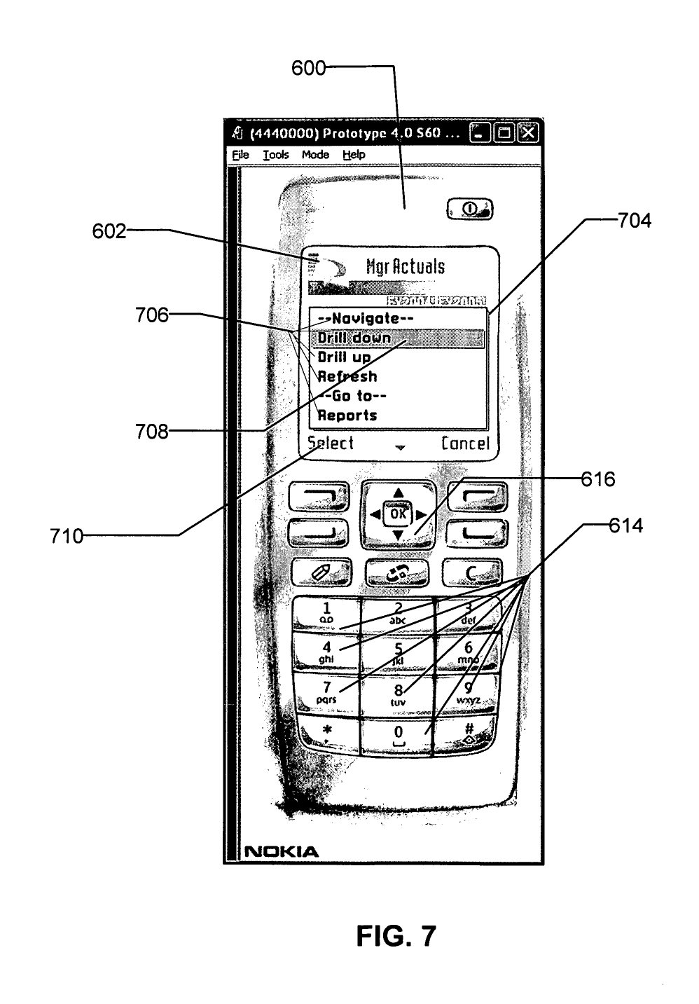

FIG. 7 illustrates a GUI associated with an embodiment of the invention. A menu 704 is provided where menu items 706 can be selected. “Drill down” 708 is highlighted and can be selected at toolbar 710. In one embodiment of the invention, the menu contains the following single click control items and functionality:

| | |
|---|---|
| Navigate | No action (visual separator). |
| Next page (6) | Open next report page. |
| Previous page (4) | Open previous report page. |
| First page | Jump to first report page. |
| Last page | Jump to last report page. |
| Drill down | Appears only on drillable cells. |
| Drill up | Appears only on drillable cells. |
| Refresh | Refresh the current report on the report server. |
| Go to | No action (visual separator). |
| Reports | Jumps to the list of report tabs within the current report |
| | to allow users to navigate to other tabs. This appears |
| | only in documents with multiple report tabs. |
| Document list | Jumps to the list of documents in the report repository. |
| Settings | No action (visual separator). |
| Set as default | Sets the current report as the home page for single |
| | key access. |
| Change settings | Change/set default report, default document or |
| | server settings. |
| Display options | Shows the report navigation keys help screen below: |
| | Toggle info bar, full screen, lock/unlock headers, |
| | 100% rendering, zoom out, fit to screen, zoom in. |
| Exit | Exit the application. |

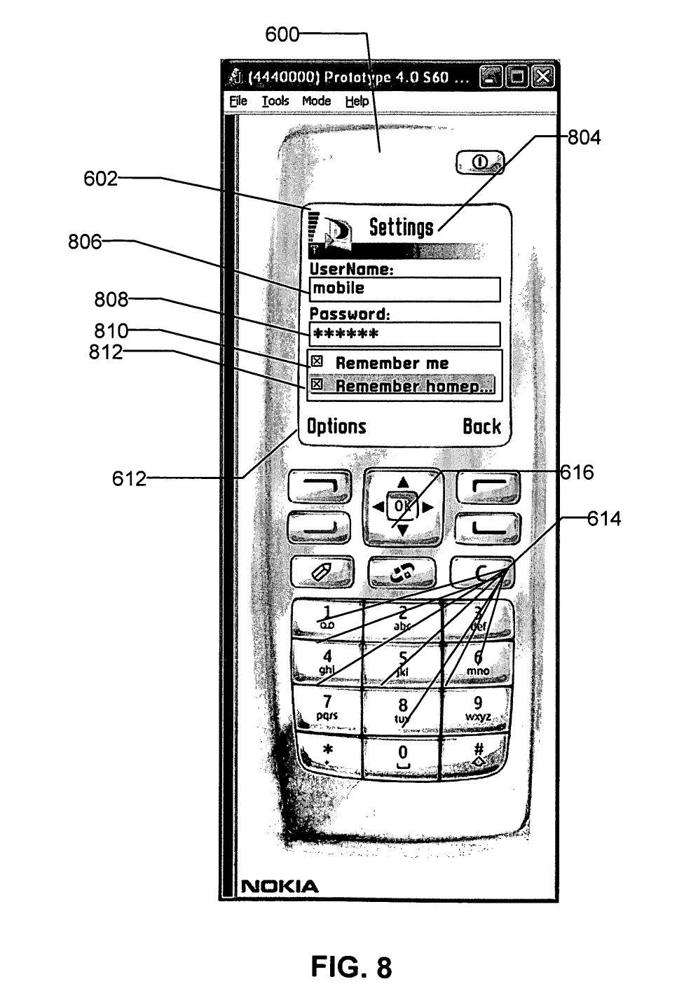

FIG. 8 illustrates a GUI for setting default options. Selecting “Set as Default” from the menu 704 supplied in FIG. 7, displays a graphical user interface 804 for setting default options. Using this GUI a user specifies user name 806, password 808, and optionally a “Remember me” 810 option that stores the user information and uses it when requesting a report from the server. A “Remember homepage” 812 option that associates the user with a report homepage and displays this homepage by default when the user opens the application on a mobile communication device may also be used. In one embodiment, remembering the homepage includes remembering other information such as filters, parameters, a specific view or tab of the report, specific display options such as font size and zoom, and the like.

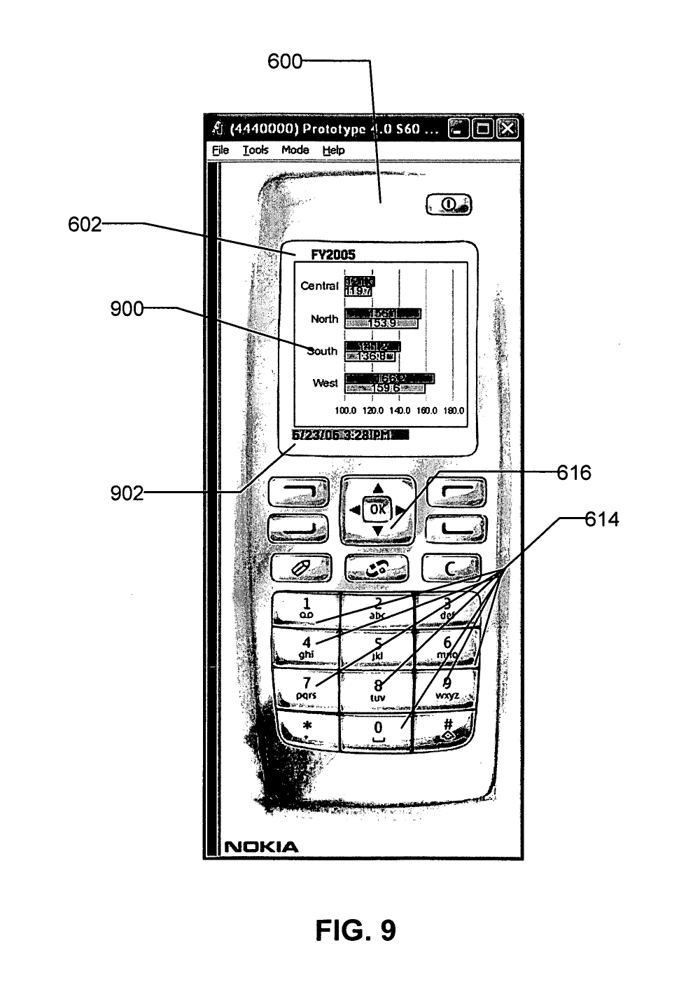

FIG. 9 illustrates a GUI associated with an embodiment of the invention. In the display 602, a report 900 showing a bar chart is displayed. The mobile communication device application displays the range of charts available in the report design tool such as bar charts, pie charts, line charts, scatter plots, and the like.

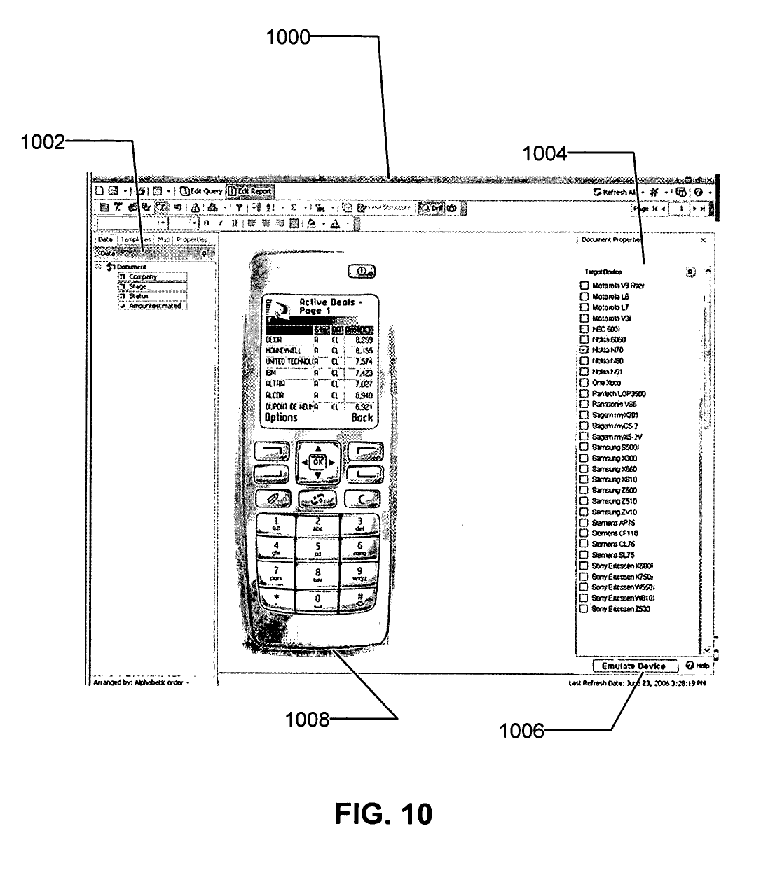

FIG. 10 illustrates a report design tool associated with an embodiment of the invention. The report design tool 1000 contains standard components to support the selection of data 1002 for a report. In addition, functionality specific to designing reports for mobile devices is available. For example, a template for the mobile communication device 1008 can be displayed, additional target devices can be selected 1004, and device emulation can be initiated 1006.

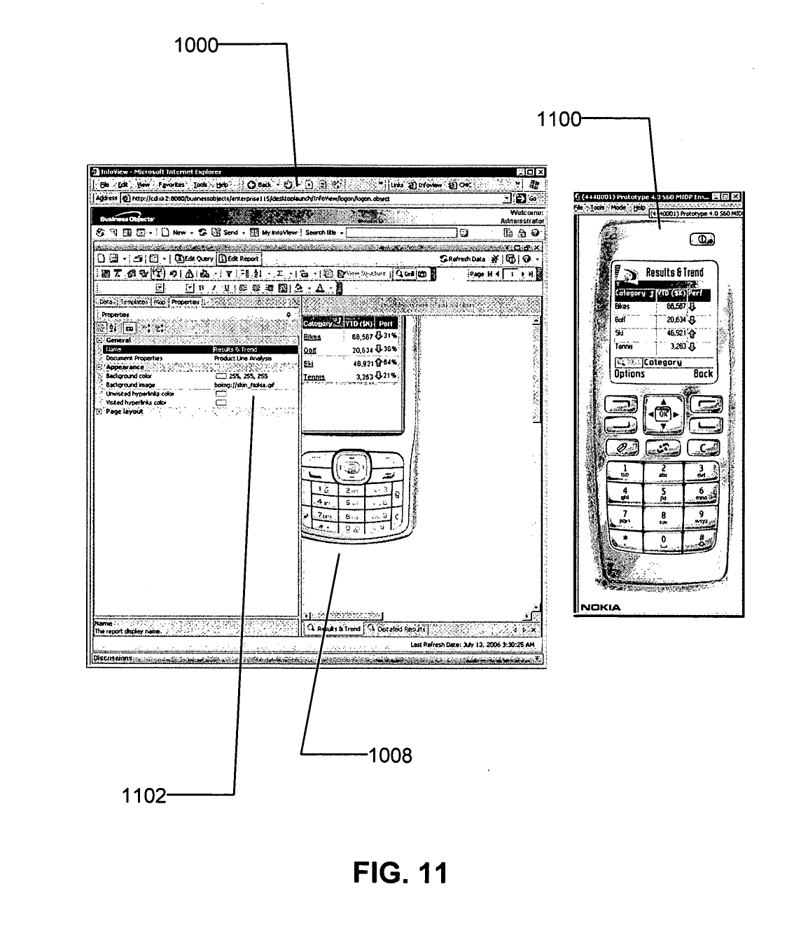

FIG. 11 illustrates a report design tool associated with an embodiment of the invention. The report design tool 1000 provides the ability to select appearance options including selecting a template for the mobile communication device 1102. An emulator 1100 can be launched from the report design tool 1000 to enable a report designer to test interactive functionality using a specific mobile communication device emulation. Thus, the emulator 1100 allows one to preview the appearance of a report on a mobile communication device.

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hardwired circuitry in place of, or in combination with, machine-executable software instructions, such as executing a query against a database.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A computer implemented method, comprising:
authenticating a user of a mobile communication device;
processing a request from the mobile communication device for report content; and
transmitting the report content to the mobile communication device.

2. The computer implemented method of claim 1 wherein processing includes checking user rights to access the report content.

3. The computer implemented method of claim 1 wherein processing includes processing specified parameters associated with the report content.

4. The computer implemented method of claim 1 wherein transmitting includes responding to degraded network conditions by varying packet size.

5. A computer implemented method, comprising:
receiving a request to view a report document on a mobile communication device;
passing the request over a wireless channel to a server;
receiving a report document from the server over a wireless channel; and
displaying the report document on the mobile communication device.

6. The computer implemented method of claim 5 further comprising:
augmenting the report document with navigation options to produce an augmented report document for display on the mobile communication device; and
displaying the augmented report document on the mobile communication device.

7. The computer implemented method of claim 6 further comprising:
receiving user navigation input specifying revised report content;
fetching the revised report content; and
displaying the revised report content.

8. The computer implemented method of claim 6 wherein augmenting includes generating navigation tabs.

9. The computer implemented method of claim 6 wherein augmenting includes adding a control to facilitate zoom onto a cell of the augmented report document.

10. The computer implemented method of claim 6 wherein augmenting includes adding a control to toggle between an actual size view and a fit to screen view.

11. The computer implemented method of claim 6 wherein augmenting includes adding a control to facilitate single click control to view, refresh and drill.

12. The computer implemented method of claim 6 wherein augmenting includes interpreting and modifying report content to natively render the report content for a specific type of mobile communication device.

13. A computer readable medium comprising executable instructions for facilitating the design of a report for use and display on a mobile communication device, comprising executable instructions to:
receive information identifying a data source;
accept information specifying a mobile communication device;
display the mobile communication device; and
save a report to a location accessible to the mobile communication device.

14. The computer readable medium of claim 13 further comprising executable instructions to provide a device specific design template.

15. The computer readable medium of claim 13 further comprising executable instructions to validate a report design that will be displayed on a mobile device.

16. The computer readable medium of claim 15 further comprising executable instructions to facilitate the display of an emulated mobile communication device.

17. A computer readable medium comprising executable instructions for viewing reports on a mobile communication device, comprising executable instructions to:
receive a report document;
interpret the report document; and
render the report document on the mobile communication device.

18. The computer readable medium of claim 17 further comprising executable instructions to accept user input to navigate the report document on the mobile communication device.

19. The computer readable medium of claim 18 wherein the executable instructions to accept user input include executable instructions to facilitate drill down, drill up, tab selection, zoom, hot keys, and single click action.
